(19) United States
(12) Patent Application Publication
(10) Pub. No.: US 2007/0000779 A1
(43) Pub. Date: Jan. 4, 2007

(54) Sensor element

(76) Inventors: Berndt Cramer, Leonberg (DE); Bernd Schumann, Rutesheim (DE); Jorg Ziegler, Rutesheim (DE)

Correspondence Address: KENYON & KENYON LLP, ONE BROADWAY, NEW YORK, NY, 10004, US

(21) Appl. No.: 10/574,058

(22) PCT Filed: Sep. 29, 2004
(86) PCT No.: PCT/DE04/02179

§ 371 Date: Mar. 29, 2006

(51) Int. Cl. G01N 27/26

(52) U.S. Cl. 204/424

(57) ABSTRACT

A sensor element is described, which is used in particular for detecting a physical property of a measuring gas, preferably for determining the oxygen partial pressure in an exhaust gas of an internal combustion engine. The sensor element contains at least one electrochemical measuring cell, which includes a first electrode and a second electrode, which are electrically connected by a solid electrolyte. The second electrode is in a gas chamber, which is connected to the measuring gas located outside the sensor element via a first element having a catalytically active material and a second diffusion-limiting element. The first element has a length of at least 1 mm in the diffusion direction of the measuring gas.

### FIELD OF THE INVENTION

The present invention is directed to a sensor element.

### BACKGROUND INFORMATION

A sensor element of this type is known, for example, from Automotive Electronics Handbook, Editor: Ronald Jurgen, Chapter 6, McGraw-Hill, 1995. The planar sensor element has a first and a second solid electrolyte film, between which a measuring gas chamber is introduced. A diffusion barrier is connected upstream from the measuring gas chamber. The measuring gas located outside the sensor element may reach the measuring gas chamber via a measuring gas opening introduced into the first solid electrolyte film and via the diffusion barrier.

An internal pump electrode and a Nernst electrode are situated in the measuring gas chamber. The internal pump electrode forms an electrochemical pump cell together with an external pump electrode applied to an external surface of the sensor element and the region of the first solid electrolyte film lying between the internal pump electrode and the external pump electrode. The Nernst electrode works together with a reference electrode subjected to a reference gas and with the solid electrolyte situated between the Nernst electrode and the reference electrode; the cited elements form an electrochemical Nernst cell, via which the oxygen partial pressure in the measuring gas chamber is determined. By applying a pumping voltage, oxygen is pumped into or out of the measuring gas chamber by the pump cell in such a way that there is an oxygen partial pressure of approximately lambda=1 in the measuring gas chamber. For this purpose, the pumping voltage is regulated using analysis electronics in such a way that the Nernst voltage applied to the Nernst cell corresponds to a setpoint value of 450 mV, for example. In the event of lean exhaust gas, all of the oxygen flowing through the diffusion barrier is pumped off by the pump cell because of this regulation. Since the quantity of oxygen flowing through the diffusion barrier is a measure of the oxygen partial pressure of the measuring gas, the oxygen partial pressure in the measuring gas may be concluded on the basis of the pumping current. In the event of rich exhaust gas, oxidizable components of the measuring gas (such as hydrocarbons, H₂, CO) flow through the diffusion barrier into the measuring gas chamber. The oxidizable components of the measuring gas react with the oxygen pumped into the measuring gas chamber by the pump cell. The oxygen partial pressure in the exhaust gas may again be determined on the basis of the pumping current.

The described determination of the oxygen partial pressure assumes that the measuring gas is in thermodynamic equilibrium. If this is not the case, oxidizable and reducible gas components exist next to one another, so the measurement result is corrupted, since the oxidizable and the reducible gas components have different diffusion constants and therefore diffuse at different speeds through the diffusion barrier into the measuring gas chamber. A similar effect occurs in the event of rich exhaust gas, in which, in addition to the rich gas components of H₂, CO, and hydrocarbons, there is also residual oxygen (multicomponent measuring gas). However, the proportions of the various components may vary. Since the various components have different diffusion coefficients, the measuring result is corrupted. Unbalanced measuring gases or multicomponent measuring gases of this type particularly occur during the regeneration phase of diesel particle filters or in rich exhaust gas, during the regeneration of an NOₓ accumulator-type catalytic converter, for example.

Furthermore, coating a region of the diffusion barrier with a catalytically active material is known from DE 100 13 882 A1. The reaction of the oxidizable components with the reducible components of the unbalanced measuring gas is accelerated by the catalytically active material, in such a way that the measuring gas is in thermodynamic equilibrium after flowing through the region of the diffusion barrier having the catalytically active material. The catalytically active material is situated on the diffusion barrier as a thin layer, or the catalytically active material is provided inside the gas inlet opening. The gas inlet opening is introduced into a solid electrolyte film on which the internal pump electrode and the external pump electrode are situated on diametrically opposite sides. For this purpose, it is disadvantageous that the diffusion path of the measuring gas through the catalytically active material is very short and is at most in the range of 0.5 mm. Because of the short diffusion path, the measuring gas may not be completely brought into thermodynamic equilibrium, through which the measuring signal is corrupted.

### SUMMARY OF THE INVENTION

In contrast, the sensor element according to the present invention has the advantage that the sensor element may measure the oxygen partial pressure of the measuring gas with an outstanding response rate, and precise measurement of the oxygen partial pressure is simultaneously possible, even in the event of unbalanced measuring gas or multicomponent measuring gas, i.e., if the measuring gas is not provided in thermodynamic equilibrium and therefore in a largely defined composition.

For this purpose, the sensor element has a first electrode and a second electrode, which are electrically connected by a solid electrolyte and form an electrochemical cell. The second electrode is situated in a gas chamber which is connected to the measuring gas located outside the sensor element via a first element, which has a catalytically active material, and a second diffusion-limiting element (diffusion barrier). In order to ensure that the measuring gas is in thermodynamic equilibrium upon entry into the second element and into the gas chamber, the first element has a length of at least 1 mm in the diffusion direction of the measuring gas. It is thus ensured that the measuring gas interacts with the catalytically active material of the first area in such a way that the measuring gas is brought into thermodynamic equilibrium.

The first element may be implemented as a cavity whose internal walls are coated with the catalytically active material. The first element especially preferably has a porous design, the measuring gas diffusing through the pores of the porous first element and coming into contact with the catalytically active material at the same time. For this purpose, it is advantageous that the catalytically active material is able to interact with the measuring gas particularly frequently on a short diffusion path, so that the measuring gas is brought into thermodynamic equilibrium particularly reliably.

The impairment of the measuring signal by a measuring gas which is not completely in thermodynamic equilibrium may be avoided particularly effectively by using a sensor element in which the first element has a length in the range of 1.5 mm to 20 mm, especially preferably in the range from 2 mm to 5 mm, in the diffusion direction of the measuring gas, or in which the volume of the first element filled with a porous material is in the range from 1 mm³ to 20 mm³, particularly 2 mm³ to 10 mm³, for example, 6 mm³, or in which the first element is a channel filled with porous material, the height of the first element being in the range from 0.1 mm to 0.5 mm, in particular 0.3 mm, and/or the width of the first element being in the range from 1 mm to 4 mm, in particular 3 mm. In a first element whose longitudinal extension is parallel to the layer plane of the sensor element, the height of the first element in the framework of this publication is understood as its dimension perpendicular to the layer plane of the sensor element and the width of the first element is understood as its dimension in the direction perpendicular to the diffusion direction and perpendicular to the height.

In order to keep the diffusion resistance of the first element low, the diffusion cross section of the first element is at least twice as large as the diffusion cross section of the second element. The diffusion cross section is understood in this publication as the open area (i.e., the area through which the gas may diffuse) in the plane perpendicular to the diffusion direction. In a porous material, the diffusion cross section corresponds to the area of the cavities formed by the pores.

A constriction, whose diffusion cross section is smaller than the diffusion cross section of the first element, is particularly preferably provided on the side of the first element facing toward the measuring gas located outside the sensor element. The measuring gas located outside the sensor element frequently has high flow velocities and pulsations (pressure spikes), which may cause strong pressure changes in the gas chamber. These flows and pulsations of the measuring gas are advantageously damped by the constriction and thus the pressure changes in the gas chamber are reduced. The constriction may, for example, be implemented by a porous material having a low proportion of pores or by a channel having a correspondingly reduced cross section. The diffusion cross section of the constriction is preferably 10% to 80%, in particular 20% to 40%, of the diffusion cross section of the first element, or the length of the constriction in the diffusion direction is 10% to 100% of the length of the first element, or a porous material is provided in the area of the constriction whose mean pore diameter is in the range from 5% to 20% of the largest cross section of the constriction.

### BRIEF DESCRIPTION OF THE DRAWINGS

FIG. 1 shows a longitudinal section through a first exemplary embodiment of a sensor element according to the present invention.

FIG. 2 shows a section along line II-II in FIG. 1.

FIG. 3 shows a longitudinal section through a second exemplary embodiment of the sensor element according to the present invention.

FIG. 4 shows a section along line IV-IV in FIG. 3.

FIG. 5 shows a longitudinal section through a third exemplary embodiment of a sensor element according to the present invention.

FIG. 6 shows a section in the plane of FIGS. 2 and 4 through a fourth exemplary embodiment of a sensor element according to the present invention.

### DETAILED DESCRIPTION

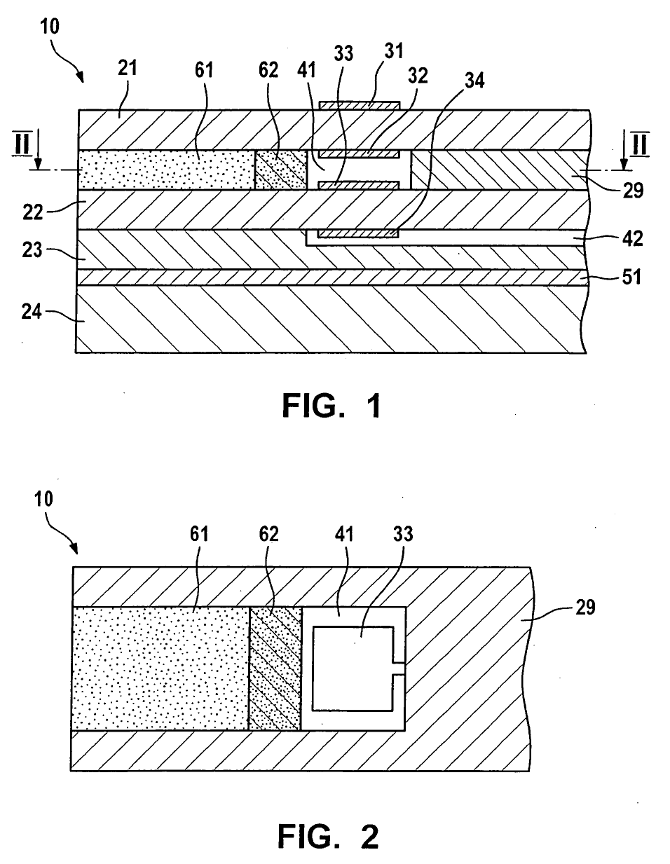

FIGS. 1 and 2 show, as the first exemplary embodiment of the present invention, a sensor element 10 having a first solid electrolyte layer 21, a second solid electrolyte layer 22, a third solid electrolyte layer 23, and a fourth solid electrolyte layer 24. A first electrode 31, which is exposed to the measuring gas and is coated with a protective layer (not shown), is provided on the side of first solid electrolyte layer 21 which forms an external side of sensor element 10. A second electrode 32 is situated diametrically opposite first electrode 31 on first solid electrolyte layer 21 in a gas chamber 41. Gas chamber 41 is situated inside sensor element 10 between first solid electrolyte layer 21 and second solid electrolyte layer 22. A third electrode 33 is situated in gas chamber 41 on second solid electrolyte layer 22—diametrically opposite second electrode 32. A fourth electrode 34 is situated diametrically opposite third electrode 33 on second solid electrolyte layer 22 in a reference gas chamber 42. Reference gas chamber 42 is provided between second solid electrolyte layer 22 and third solid electrolyte layer 23 and contains a reference gas, in particular having a high proportion of oxygen. A heating element 51 is situated between third and fourth solid electrolyte layers 23, 24, using which sensor element 10 may be heated to the required operating temperature.

Gas chamber 41 is connected to the measuring gas located outside sensor element 10 via a first element 61 and a second element 62, second element 62 being situated between first element 61 and gas chamber 41. First element 61, second element 62, and gas chamber 41 are situated in a channel, which is laterally sealed by a sealing frame 29, extending along the longitudinal axis of sensor element 10 and between first and second solid electrolyte layers 21, 22.

The mode of operation of sensor element 10 is described in Automotive Electronics Handbook, Editor: Ronald Jurgen, Chapter 6, McGraw-Hill, 1995.

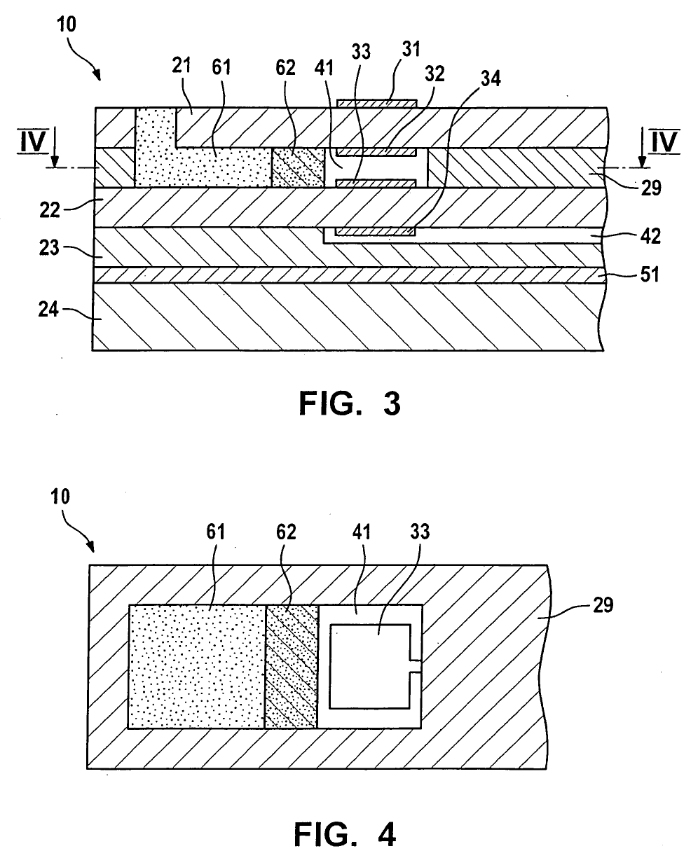

The second exemplary embodiment of the present invention illustrated in FIGS. 3 and 4 differs from the first exemplary embodiment in that first element 61 initially extends from second element 62 along the longitudinal axis of sensor element 10 and between first and second solid electrolyte layers 21, 22 and subsequently through an opening in first solid electrolyte 21 up to the external side of sensor element 10.

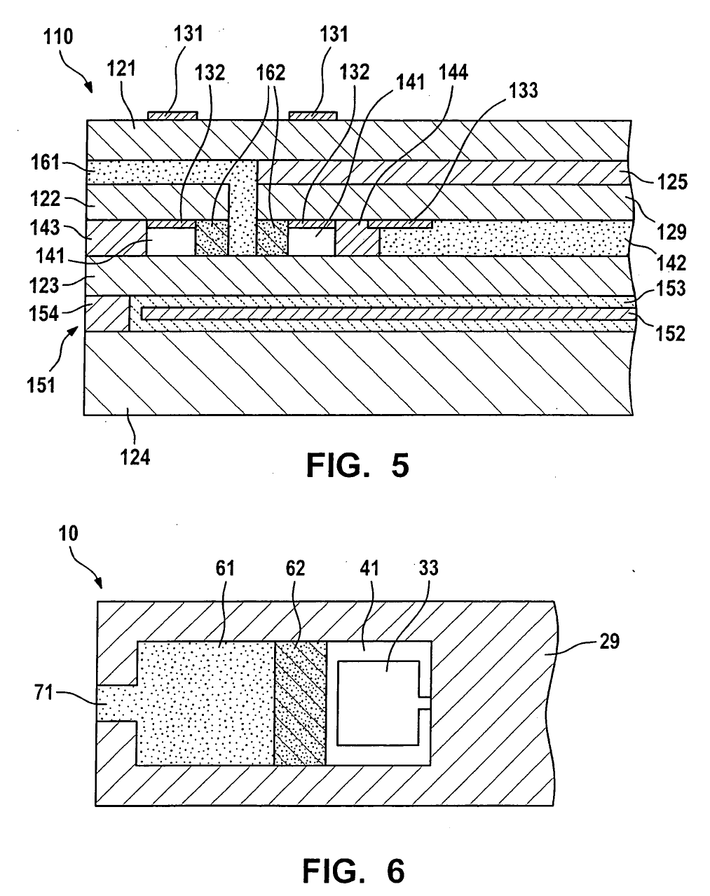

The third exemplary embodiment illustrated in FIG. 5 differs from the first and second exemplary embodiments in that, among other things, the electrodes and the diffusion barriers have an annular design.

Sensor element 110 according to the third exemplary embodiment illustrated in FIG. 5 has a first solid electrolyte layer 121, a second solid electrolyte layer 122, a third solid electrolyte layer 123, and a fourth solid electrolyte layer 124, as well as an intermediate layer 125 made of a solid electrolyte. Annular first electrode 131 is situated on the external surface of first solid electrolyte layer 121. A gas chamber 141 is provided between second and third solid electrolyte layers 122, 123. An annular second electrode 132 is situated in gas chamber 141 on second solid electrolyte layer 122. Furthermore, a reference gas chamber 142 is provided in the layer plane of gas chamber 141, in which a third electrode 133 is situated on second solid electrolyte layer 122, which is exposed to a reference gas having a high proportion of oxygen.

The gas located outside the sensor element may reach gas chamber 141 via a first element 161 and a second element 162. A first section of first element 161 extends in the layer plane between first and second solid electrolyte layers 121, 122 parallel to the longitudinal axis of sensor element 10 and subsequently runs through an opening in second solid electrolyte layer 122 up into the middle of annular second element 162. Second element 162 is situated inside annular gas chamber 141 between second and third solid electrolyte layers 122, 123. Gas chamber 141 is thus connected via second element 162 and first element 161 to the gas located outside sensor element 10.

First element 161 is laterally enclosed by intermediate layer 125 in the area between first and second solid electrolyte films 121, 122.

First and second electrodes 131, 132 are electrically connected by first solid electrolyte layer 121, intermediate layer 125, and second solid electrolyte layer 122.

Furthermore, a heating element 151 is provided between the third and fourth solid electrolyte layers, which includes a heating conductor 152, which is insulated from surrounding layers 123, 124 by a heater insulation 153. Heating conductor 152 and heater insulation 153 are laterally enclosed by a heater sealing frame 154. The construction of heating element 51 of the first and second exemplary embodiments corresponds to that of heating element 151 according to the third exemplary embodiment.

First element 61, 161 is a channel filled with a porous material which extends at least partially in a layer plane, i.e., parallel to the large surface areas of solid electrolyte films 21, 22, 23, 24, 121, 122, 123, 124. The porous material contains a noble metal and/or a mixture or alloy containing a noble metal as the catalytically active material. For example, platinum, rhodium, or palladium or a mixture or alloy of the elements cited is used as a noble metal. A porous ceramic, which contains aluminum oxide, for example, may be provided as a support structure for the catalytically active material, the catalytically active material being provided in the pores of the porous support ceramic.

The measuring gas located outside the sensor element diffuses through first element 61, 161 to second element 62, 162 and then into gas chamber 41, 141. The diffusion length through first element 61, 161 is 3 mm. The channel in which first element 61, 161 is situated has a cross-sectional area (i.e., the area enclosed by the internal delimitation perpendicular to the longitudinal extension) of approximately 0.4 mm², the height being approximately 0.2 mm and the width being approximately 2 mm. In the second exemplary embodiment shown in FIGS. 3 and 4 and the third exemplary embodiment shown in FIG. 5, first element 61, 161 has a section having a longitudinal extension perpendicular to the layer plane of sensor element 10 which extends through an opening in one of the solid electrolyte layers. In this section, which preferably has a circular cross section, the cross-sectional area is also approximately 0.4 mm².

Second diffusion-limiting element 62, 162 is a diffusion barrier whose diffusion cross section is significantly smaller than the diffusion cross section of first element 61, 161. The diffusion cross section of second element 62, 162 is approximately 0.1 mm², for example, while the diffusion cross section of first element 61, 161 is 0.35 mm². The diffusion resistance which delimits the diffusion of the gas into gas chamber 41, 141 is thus essentially provided by the diffusion resistance of second element 62, 162.

A further exemplary embodiment of the present invention, which may be applied to the exemplary embodiments according to FIGS. 1 through 5, is provided in FIG. 6. The sectional plane of FIG. 6 corresponds to the sectional plane of FIGS. 2 and 4. A constriction 71 is provided on the side of first element 61 facing away from second element 62. Constriction 71 has a smaller diffusion cross section than first element 61. For this purpose, constriction 71 has a smaller cross-sectional area than the channel in which first element 61 is situated. The length (along the diffusion direction) of constriction 71 is 50% of the length of first element 61, and the cross-sectional area of constriction 71 is 30% of the cross-sectional area of first element 61.

Alternatively, the constriction may be filled with a porous material whose proportion of pores is less than the proportion of pores in the first element.

The channel in which the first element is situated may also be implemented as snaking or meandering, in particular in the layer plane of the solid electrolyte films, in order to thus lengthen the diffusion path within the first element.

The present invention may also be applied to a sensor element which has two electrochemical cells connected in parallel, one electrochemical cell having a first element according to the present invention which is connected upstream from the second element (diffusion barrier), and a catalytically active first element of this type not being provided in the other electrochemical cell.

1.-12. (canceled)

13. A sensor element, comprising:
a solid electrolyte;
at least one electrochemical measuring cell including a first electrode and a second electrode that are electrically connected by the solid electrolyte;
a first element including a catalytically active material and a second diffusion-limiting element;
a gas chamber communicating with a measuring gas located outside of the sensor element via the first element and in which the second electrode is situated, wherein the first element has a length of at least 1 mm in a diffusion direction of the measuring gas.

14. The sensor element as recited in claim 13, wherein:
the sensor element is for detecting a physical property of a measuring gas.

15. The sensor element as recited in claim 13, wherein:
the sensor element is for determining an oxygen partial pressure in an exhaust gas of an internal combustion engine.

16. The sensor element as recited in claim 13, wherein at least one of the first element and the second diffusion-limiting element includes at least regionally a porous design.

17. The sensor element as recited in claim 13, wherein the first element has a length in the range from 1.5 mm to 20 mm in the diffusion direction of the measuring gas.

18. The sensor element as recited in claim 13, wherein the first element has a length in the range of 2 mm to 5 mm.

19. The sensor element as recited in claim 16, wherein a proportion of pores in the first element is at least twice as large as a proportion of pores in the second diffusion-limiting element.

20. The sensor element as recited in claim 13, wherein a volume of the first element filled with a porous material is in the range from 1 mm³ to 20 mm³.

21. The sensor element as recited in claim 13, wherein a volume of the first element filled with a porous material is in the range from 2 mm³ to 10 mm³.

22. The sensor element as recited in claim 13, wherein a diffusion cross section of the first element is at least twice as large as a diffusion cross section of the second diffusion-limiting element.

23. The sensor element as recited in claim 13, wherein at least one of:
the first element includes a channel filled with a porous material,
a height of the first element is in a range from 0.1 mm to 0.5 mm, and
a width of the first element is in the range from 1 mm to 4 mm.

24. The sensor element as recited in claim 13, wherein at least one of:
the first element includes a channel filled with a porous material,
a height of the first element is 0.3 mm, and
a width of the first element is 3 mm.

25. The sensor element as recited in claim 13, wherein the second diffusion-limiting element is situated between the first element and the gas chamber.

26. The sensor element as recited in claim 13, further comprising:
a constriction having a diffusion cross section that is smaller than a diffusion cross section of the first element, the constriction being is provided on a side of the first element facing toward the measuring gas.

27. The sensor element as recited in claim 26, wherein at least one of:
the diffusion cross section of the constriction is 10% to 80% of the diffusion cross section of the first element, and
a length of the constriction in the diffusion direction is 10% to 100% of the length of the first element.

28. The sensor element as recited in claim 26, wherein at least one of:
the diffusion cross section of the constriction is 20% to 40% of the diffusion cross section of the first element, and
a length of the constriction in the diffusion direction is 10% to 100% of the length of the first element.

29. The sensor element as recited in claim 27, further comprising:
a porous material provided in an area of the constriction, a mean pore diameter of which is in the range from 5% to 20% of a largest cross section of the constriction.

30. The sensor element as recited in claim 13, wherein at least one of the first element and the second diffusion-limiting element is at least regionally provided in a layer plane of the measuring gas chamber.
